(19) United States
(12) Patent Application Publication
(10) Pub. No.: US 2008/0079716 A1
(43) Pub. Date: Apr. 3, 2008

(54) MODULATING FACIAL EXPRESSIONS TO FORM A RENDERED FACE

(76) Inventor: Thomas W. Lynch, Austin, TX (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/537,532

(22) Filed: Sep. 29, 2006

(51) Int. Cl. G06T 15/00

(52) U.S. Cl. 345/419

(57) ABSTRACT

Embodiments of methods, devices and/or systems for modulating facial expressions to form a rendered face having an expression are described.

### FIELD

This disclosure is related to data acquisition, data modulation, and modulating facial expressions in accordance with a facial model and in response to acquired data, to form a rendered face having a facial expression. The facial expression may be displayed on an electronic display, and may convey and/or represent the acquired data.

### BACKGROUND

Facial expressions may provide cognitive signals that convey a message. Messages may provide data to an observer of the facial expressions, such as the emotional state of the provider of the facial expression. The human brain is adept at detecting and interpreting facial expressions. The messages that may be obtained from facial expressions may transcend language, education and social barriers. For example, a section of the human brain is particularly adept at detecting and interpreting facial signals. See, for example, “Emotions Revealed: Recognizing Faces and Feelings to Improve Communication and Emotional Life”, Paul Ekman, Owl Books (NY); Reprint edition (March 2004), ISBN 080507516X. It is theorized that the 200 muscles of the face may be capable of generating in excess of 55,000 distinct expressions. See, for example, E. Pagio Universita degli Studi di Pisa. See, for example, the following internet website: http://www.piaggio.ccii.unipi.it/bio/biohome. These expressions may be capable of being interpreted, resulting in the conveying of a message to the interpreter of the expression which may not require complex interpretation or even volitional thought. The message may convey emotional, physical and/or mental state of the subject conveying the expression, for example.

### BRIEF DESCRIPTION OF THE DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 is a schematic diagram illustrating an embodiment of a system for acquiring data that is employed to modulate expressions in accordance with a facial model to form a rendered face having an expression.

FIG. 2 is a flow diagram illustrating an embodiment of modulating expressions in accordance with a facial model to form a rendered face having an expression.

FIG. 3 is a flow diagram illustrating an embodiment of modulating expressions in accordance with a facial model to form a rendered face having an expression.

FIG. 4 is a flow diagram illustrating an embodiment of modulating expressions in accordance with a facial model to form a rendered face having an expression.

FIG. 5 is a facial feature library that may be employed in one or more embodiments.

FIG. 6 is a schematic diagram illustrating an embodiment of facial rendering employed in a computing environment.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail so as not to obscure claimed subject matter.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” and/or “an embodiment” in various places throughout this specification are not necessarily all referring to the same embodiment. Furthermore, the particular features, structures, and/or characteristics may be combined in one or more embodiments.

Unless specifically stated otherwise, as apparent from the following discussion, it is appreciated that throughout this specification discussions utilizing terms such as “processing,” “computing,” “selecting,” “receiving,” “transmitting,” “rendering,” “determining”, “modulating” and/or the like refer to the actions and/or processes that may be performed by a computing platform, such as a computer or a similar electronic computing device, that manipulates and/or transforms data represented as physical, electronic and/or magnetic quantities and/or other physical quantities within the computing platform's processors, memories, registers, and/or other information storage, transmission, reception and/or display devices. Accordingly, a computing platform refers to a system or a device that includes the ability to process and/or store data in the form of signals. Thus, a computing platform, in this context, may comprise hardware, software, firmware and/or any combination thereof. Further, unless specifically stated otherwise, a process as described herein, with reference to flow diagrams or otherwise, may also be executed and/or controlled, in whole or in part, by a computing platform.

As alluded to previously, facial expressions may provide cognitive signals that convey a message. In this context, a facial expression may include facial features, as will be explained later. For a variety of reasons, it may be desirable to acquire data from one or more sources, and modulate facial expressions in accordance with a facial model and in response to the data. The facial expressions may be modulated according to the facial model to result in forming a rendered face in accordance with the facial model. The rendered face may include an expression or expressions, and may include facial features that convey and/or represent the acquired data. This may be performed, at least in part, in a computing environment.

Of course, many techniques or implementations are possible within the scope of claimed subject matter, and claimed subject matter is not limited in scope to this particular example. For convenience, in this context, with respect to describing particular embodiments, an implementation of modulating facial expressions according to a facial model in response to acquired data to form a rendered face is described in the context of a computing system or network. Again, this is one example implementation and other implementations other than this particular example are possible and intended to be covered by claimed subject matter. Additionally, although explained in the accompanying embodiments as a human face, a facial model employed in embodiments may include human or non-human faces and, likewise, other types of faces, such as “emoticons”, cartoons, caricatures and/or sketches may be employed to form a rendered face, and the claimed subject matter is not limited in this respect.

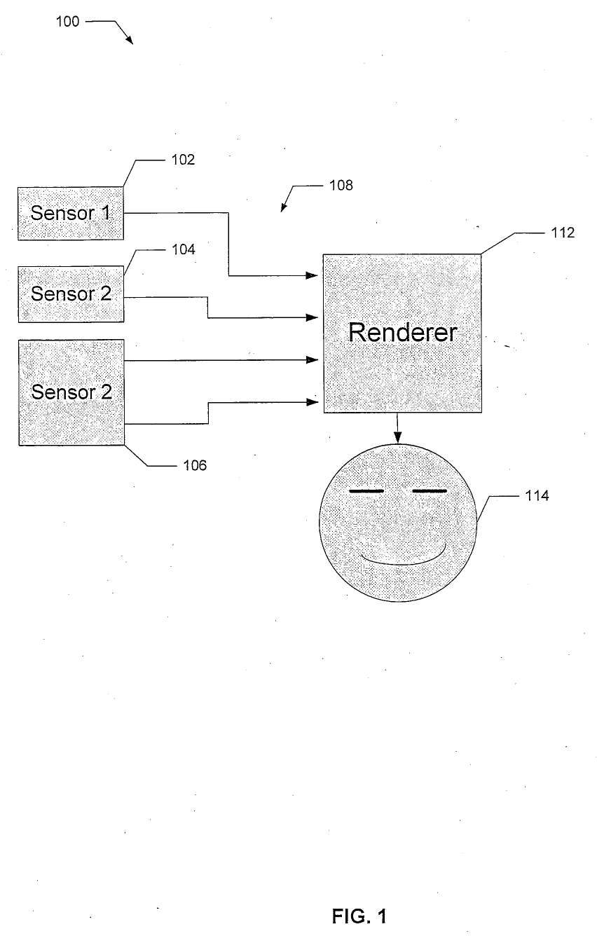

FIG. 1 is a schematic diagram illustrating an embodiment of a system 100 in which facial expressions are modulated in response to acquired data. The facial expressions are modulated according to the facial model to form a rendered face having an expression, although claimed subject matter is not limited in this respect. In this particular embodiment, system 100 includes a plurality of sensors 102, 104 and 106. This plurality of sensors may comprise one or more types of sensors adapted to acquire data, and may be implemented in a computing system and/or computing network. The sensors are employed in a variety of ways in the computing system or network, but the claimed subject matter is not limited in this respect. A renderer 112 receives data acquired at sensors 102, 104 or 106 via data path 108. Renderer 112 may be implemented in, any combination of hardware, software or firmware, for example, and may be adapted to modulate facial expressions in response to acquired data according to a facial model (not shown). Although modulating facial expressions in response to acquired data and according to a facial model will be explained in more detail later, in one embodiment, modulating facial expressions according to a facial model provides a rendered face having an expression or expressions. The expression or expressions may convey and/or represent the acquired data, such that an observer of the rendered face is able to at least partially determine or perceive the data being conveyed and/or represented. In a particular embodiment, a face is rendered on a CRT monitor or LCD, as just a few examples. The rendered face is employed in a computing environment to convey and/or represent the condition of a computing system, for example.

As stated previously, acquired data may be employed to modulate facial expressions according to a facial model. A face is rendered in accordance with the facial model to form a rendered face having an expression or expressions. The expression or expressions may convey and/or represent the acquired data. In one embodiment, the facial model comprises a mathematical model, such as a matrix of numerical values. Such a matrix may include values that correspond to portions of a rendered face. Accordingly, altering particular values of the matrix may result in alteration of a corresponding portion of a rendered face. For example, alteration may result in the rendered face including an expression. In one example, a facial model comprises a matrix of numerical values. Such matrix of numerical values may comprise values corresponding with portions of a face such as eyes, brow, lips, color of a face, mouth, or other portions of a face not listed in detail. Additionally, such a facial model may include a matrix of values representing simulated muscles or muscle strains of a face. In this example, altering the matrix of values (e.g., in response to acquired data) results in placing different strains on the facial muscles, which may accordingly result in altering an appearance of a rendered face, such that the rendered face includes an expression. The expression may convey and/or represent the acquired data, in at least one embodiment.

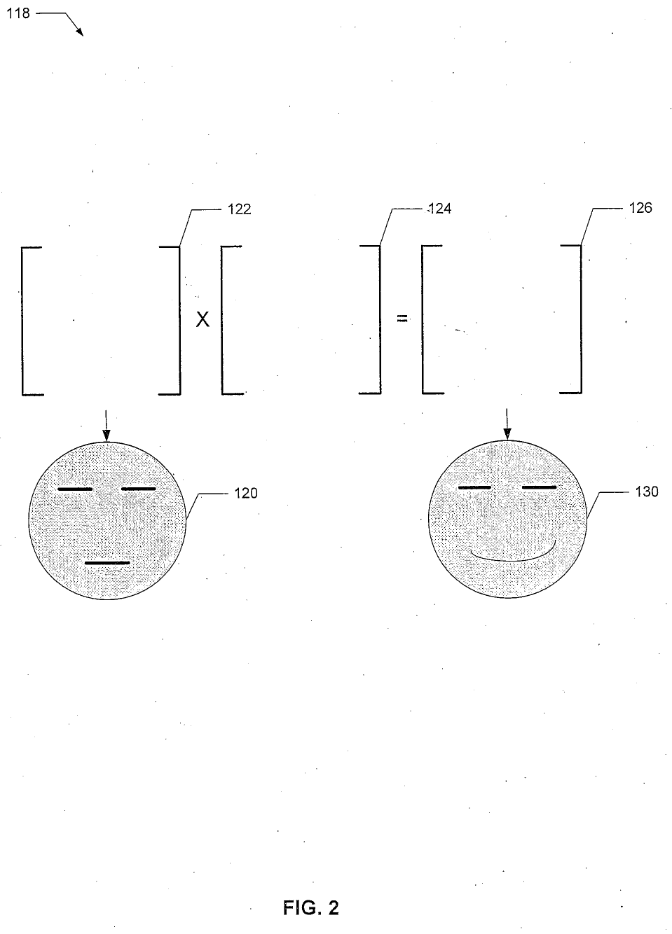

As mentioned previously, altering values of a matrix may result in rendering a face having an expression. In one embodiment, a facial model corresponds with a zero matrix. The facial model corresponding with the zero matrix may be “expressionless”, or, in other words, may not convey or represent acquired data. In order to render a face having an expression, the facial model corresponding with the “expressionless” face is altered in response to acquired data. The altering may be performed by altering the zero matrix by use of one or more mathematical operations. For example, a zero matrix is altered via linear transformation by use of a non-zero matrix. When altered, the zero matrix is altered to include non-zero values. A facial model corresponding with the altered zero matrix is accordingly modified, such that a face rendered in accordance with the modified facial model includes an expression. The expression may convey and/or represent data, such as data included in the altered zero matrix, in this embodiment. Altering a facial model matrix will be explained in greater detail with reference to FIG. 2, later.

Facial expressions may be modulated in accordance with a facial model in response to data acquired from a variety of data sources in various embodiments. Such data sources may comprise sensors, for example, but may additionally comprise other data acquisition or data collection devices. Such data sources may be communicatively coupled to portions of a computing system and/or computing network, for example. Data obtained from such data sources may represent any type of data, such as data transmission characteristics of a computing system, physical characteristics of a computing system or portions thereof, data indicative of condition and/or state of any portion of a computing system or network, for example, but it is worthwhile to note that claimed subject matter is not limited to any particular data or data source.

Referring now to FIG. 2, there is illustrated one embodiment of a method 118 of modulating facial expressions in accordance with a facial model in response to acquired data. In this embodiment, although illustrated as an empty matrix, facial model 122 comprises a matrix of numerical values. The numerical values correspond with portions of a rendered face and/or muscle strains of a rendered face, as explained previously. Rendered face 120 comprises a face rendered in accordance with the facial model 122. In this example, rendered face 120 is “expressionless”. Accordingly, in this embodiment, facial model 122 comprises a zero matrix as explained previously, although the claimed subject matter is not so limited. It may be desirable to alter the facial model 122 in accordance with acquired data to modulate a rendered face, such that the rendered face includes an expression. The expression may convey and/or represent the acquired data. The rendered face including an expression is formed by modulating facial model 122 according to acquired data.

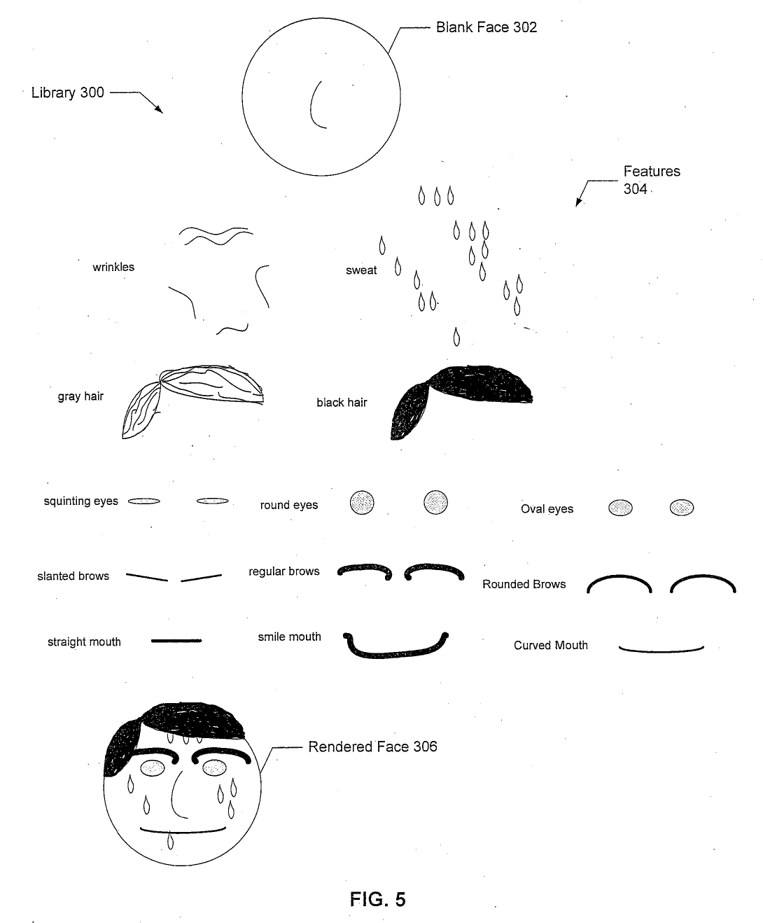

Continuing with this embodiment, facial model 122 is altered in accordance with acquired data. The acquired data is employed to alter the facial model 122, such as by use of one or more mathematical operations. In this embodiment, facial model 122 is altered by employing matrix 124, which is illustrated as an empty matrix, but comprises a matrix of numerical values in at least one embodiment. Matrix 122 is altered via linear transformation by use of matrix 124 to produce matrix 126. Matrix 126 may comprise a facial model, wherein the numerical values of the facial model are altered in accordance with acquired data. Matrix 124 may comprise a matrix of numerical values. The numerical values may comprise acquired data, or, alternatively, the numerical values may be selected based, at least in part, on the acquired data. For example, acquired data may be used to select matrix 124, and selection may be based, at least in part, on the acquired data, or may be selected based on other criteria. For example, a facial feature library (not shown) may be accessed, and facial features may be selected for inclusion on a rendered face. The selected facial features may be associated with a matrix or a portion thereof. The matrix or portion thereof may subsequently be employed to alter a facial model, such that a face rendered in accordance with the facial model may include the selected facial features. However, a facial feature library will be explained in more detail with reference to FIG. 5. Continuing with this embodiment, matrix 124 is selected in order to result in the production of a rendered face having a particular expression, such that the expression conveys and/or represents the acquired data. In this embodiment, facial model 122 is altered by employing matrix 124. A resulting facial model 126 including altered data is formed. A face 130 rendered in accordance with facial model 126 includes an expression or expressions modulated thereon. Rendered face 130 may include an expression or expressions that at least partially convey and/or represent acquired data.

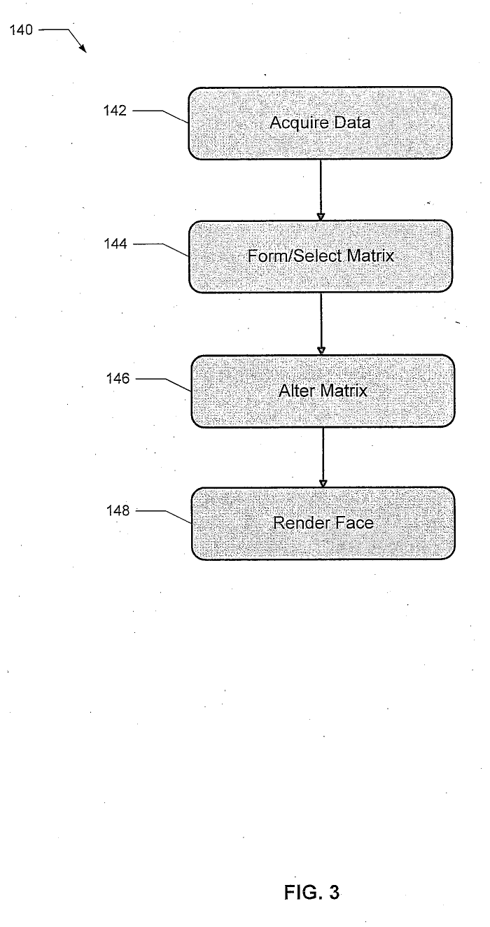

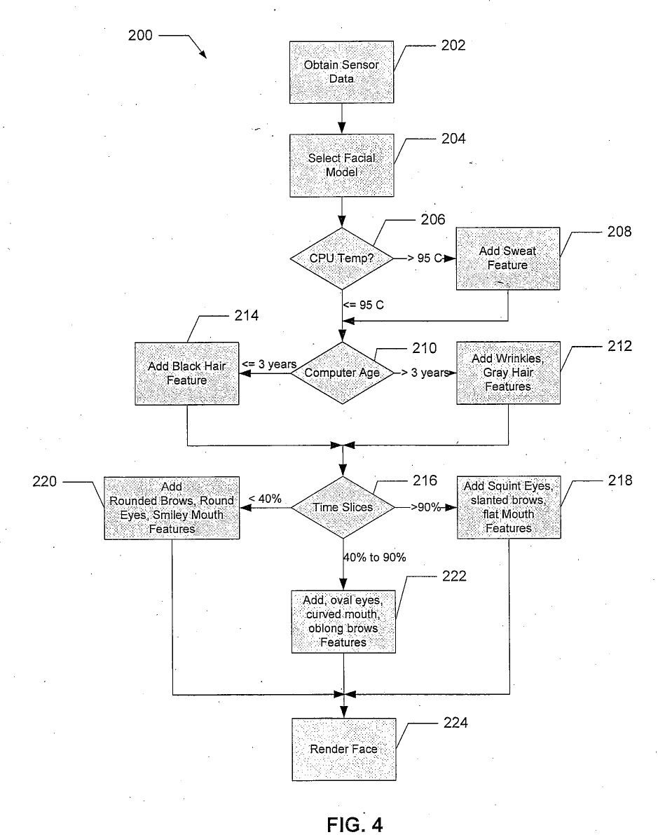

FIG. 3 shows a flow diagram illustrating a process 140 employed to modulate facial expressions in response to acquired data, and according to a facial model, to render a face having an expression. In this particular embodiment, at block 142, computing system data is acquired. Such computing system data may be acquired by use of sensors although, as indicated previously, claimed subject matter is not so limited. At block 144, acquired data is employed to select and/or form a matrix of numerical values. At block 146, a facial model matrix of values is altered. Altering the facial model matrix may result in producing a rendered face having an expression, illustrated by block 148. The rendered face includes an expression that may at least partially convey and/or represent the acquired data, such as to an observer of the face. Particular applications of the aforementioned embodiments will be explained in more detail with reference to FIGS. 4-6.

Depending at least in part on a particular application and/or system, facial rendering may be employed for a variety of reasons. For example, a face may be rendered in order to convey and/or represent data acquired by sensors 102, 104 and 106 of FIG. 1 to indicate, for example, a condition and/or state of a computing system. In one example, a server network includes a plurality of servers. Particular data may be monitored, such as condition and/or state of one or more servers. Depending on a size of the server network, monitoring data in this manner may be difficult and/or time consuming. For example, monitoring numerous servers on a continual basis may be fatiguing for a server administrator, and may not be particularly efficient. Rendering a face to convey a condition and/or state of the servers to a server administrator may be more efficient and/or less fatiguing. In this example, faces are rendered to represent associated servers of a server network, or may be rendered to represent associated aspects or portions of multiple servers, such as data rate, processor load, age of the server or temperature, to name a few examples. A server administrator may be able to rapidly scan the rendered faces to determine whether a particular server requires attention, or whether a server or network is operating in an optimal manner. This manner of monitoring the condition and/or state of the server network may be more efficient than monitoring other types of data, due to the aforementioned capability of the human brain to quickly recognize and interpret facial expressions.

In this particular embodiment, as previously suggested, it may be desirable to monitor a condition and/or state of a computing system. FIG. 4 is a flow diagram of a process 200 to monitor a condition and/or state of a computing system according to a particular embodiment. It should be understood, however, that claimed subject matter is not limited in scope to this particular example, and that the order in which blocks are presented does not necessarily limit claimed subject matter to any particular order. Additionally, intervening blocks not shown may be employed without departing from the scope of claimed subject matter. Likewise, flow diagrams depicted herein may, in alternative embodiments, be implemented as a combination of hardware, software and/or firmware, such as part of a computer or computing platform.

Continuing with the flow diagram of FIG. 4, a process 200 is adapted to monitor a condition and/or state of a computing system or a plurality of computing systems, such as a server network, for example. In this embodiment, at block 202, sensor data is obtained by use of one or more sensors that may be communicatively coupled to a computing system, such as sensors 102, 104 and 106 of FIG. 1, for example. At block 204, a facial model is selected. However, the functionality of this block may be performed at an earlier time or later in the process. At decision block 206, a sensor is employed to determine whether the temperature of a CPU exceeds a threshold. In this example, if the temperature is determined to exceed 95 degrees Celsius, at block 208, a determination may be made to alter the selected facial model such that a face rendered according to the facial model includes a sweat feature, for example. If the CPU temperature does not exceed 95 degrees Celsius, a sweat feature may not be included, for example. Such a sweat feature may be included on a rendered face by modulating the selected facial model. The facial model may comprise a matrix of numerical values, for example, and the matrix of values is altered such that a face rendered according to the altered matrix of values includes particular features. In one example, the facial model matrix is altered by a linear transformation, as explained previously. Continuing to decision block 210, data may be accessed to determine an age of the computing system. For example, if a determination is made that the computing system is greater than 3 years old, at block 212, a wrinkle feature and/or a gray hair feature may be included on a face rendered according to a facial model. However, if a determination is made that the computing system is not greater than 3 years old, no such features may be included, or a hair feature having another color, such as black, may be included.

Continuing to decision block 216 of FIG. 2, a sensor is employed to determine an allocation of time in the computing system, which may comprise portions of time used to perform individual tasks in a multitasking environment. In this example, if the allocation of time is greater than 90%, at block 218, a squinted eyes feature, a slanted brows feature and a flat mouth feature are included on a face rendered according to a facial model. Alternatively, if the allocation of time is less than 40%, at block 220, a rounded brows feature, a round eyes feature and a smile feature are included. Finally, if such time slices are determined to be 40%-90%, at block 222, an oval eyes feature, a curved mouth feature and an oblong brows feature are included on a face rendered according to a facial model. In this embodiment, at block 224, the determined features of the aforementioned blocks are employed to select and/or form a matrix of numerical values. The matrix of numerical values are employed to alter the facial model selected at block 204, to form an altered facial model matrix. A face rendered in accordance with the altered facial model matrix may include a desired expression that may include particular features selected at blocks 206-220.

In at least one embodiment, a library of facial features is employed when facial expressions are modulated according to a facial model and a face is rendered. For example, referring now to FIG. 5, there is illustrated an example library 300 of facial features included on a rendered face having an expression. In this or other embodiments, expressions, such as the aforementioned 55,000 expressions noted in the Piaggo reference, or with reference to the Facial Action Coding System (FACS) developed by Paul Ekman and Wallace Friesen may be employed to construct a library of faces, facial expressions and/or facial features that may be included on a rendered face having an expression. The FACS system is a system originally developed by Paul Ekman and Wallace Friesen in 1976, to taxonomize every conceivable human facial expression. See, for example, Ekman, P. & Friesen, W. V. “Unmasking The Face: A Guide To Recognizing Emotions From Facial Clues”, New Jersey: Prentice Hall, 1975, ISBN 0891060243, and Ekman, P., & Rosenberg, E. L. (1997), “What The Face Reveals: Basic And Applied Studies Of Spontaneous Expression Using The Facial Action Coding System (FACS)” New York: Oxford University Press, second expanded edition 2004, ISBN 0195104471. Additionally, more information may be obtained at the following internet website: http://www.cs.cmu.edu/afs/cs/proiect/face/www/facs.htm. Additionally, other non-facial features may be employed when rendering a face, such as clothing, background images or other features that may be employed to further convey a message. However, continuing with the present embodiment, the non-exhaustive list of facial features 304 may comprise a library of archetypes comprising differing features that may be utilized when forming a rendered face, such as rendered face 306. Facial features 304 may comprise eye features, hair features and/or other features that may be utilized to convey a message to an observer of a rendered face. Particular facial expressions may be employed to render a face that conveys a message of distress, concern, contentment, anger, age, sleep and alertness, as just a few examples, and these messages may be associated with a condition and/or state of a computing system. In one embodiment, individual facial features 304 may correspond with one or more matrices (not shown). A matrix corresponding with a selected feature may be employed to alter a facial model matrix, to result in an altered facial model matrix, such as described with reference to FIG. 2. A face rendered according to the altered facial model matrix may include an expression and/or features that may at least partially convey and/or represent data. Returning to a previously-described example described with reference to FIG. 4, rendered face 306 represents a computing system having a CPU in excess of 95 degrees Celsius (indicated by sweat feature), a computing system age of less than 3 years (indicated by a hair color feature), and a time slice in the vicinity of 40% to 90% (as indicated by oval eyes and curved mouth features). However, this is just one example, and claimed subject matter is not so limited.

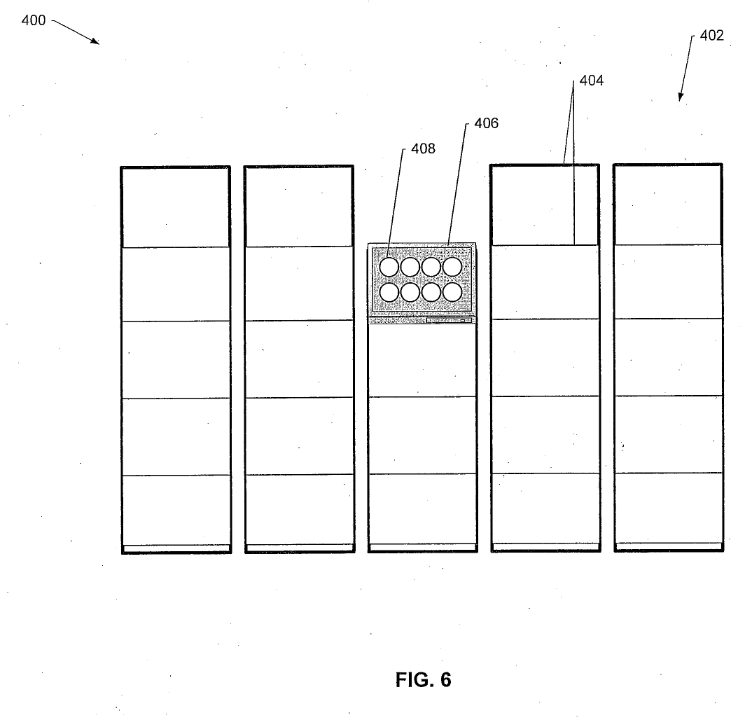

FIG. 6 is a schematic diagram illustrating an embodiment of a system 400 in which modulating data on a facial model is employed, although, again, claimed subject matter is not limited in this respect. In this particular embodiment, system 400 comprises a plurality of server racks 402. The server racks 402 include equipment 404, which may comprise servers, routers, switches, and/or other types and categories of equipment, for example. A display 406 is communicatively coupled to the equipment 404 and/or one or more sensors (not shown). One or more sensors are communicatively coupled with one or more portions of equipment 404, and may be capable of acquiring sensor data. The acquired sensor data is employed to modulate expressions in accordance with a facial model. A rendered face formed in accordance with the modified facial model includes an expression. The resulting rendered face including an expression may at least partially convey and/or represent the acquired data, as explained previously.

In at least one embodiment, a face 408 is rendered to convey and/or represent a condition and/or state of a plurality of pieces of equipment 404, such as a condition of individual devices on the racks 402. Here, a face is rendered in accordance with sensor data obtained by sensors communicatively coupled to one or more portions of a respective device. The rendered face for each respective device may convey a message regarding the condition and/or state of the device, as described previously. Rendering a face associated with one or more devices may efficiently convey and/or represent the condition and/or state of the servers to a server administrator. A server administrator is then able to rapidly scan the rendered faces to determine whether a particular server requires attention, or if a server or network is operating in an optimal manner. As mentioned previously, this manner of monitoring the condition and/or state of the server network may be more efficient than monitoring numerical data, due to the aforementioned capability of the human brain to quickly recognize and interpret facial expressions.

The following discussion details several possible embodiments for accomplishing embodiments of modulating facial expressions to form a rendered face. However, these are merely examples and are not intended to limit the scope of claimed subject matter. As another example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Likewise, although claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, computing platform, or other system, for example, may result in an embodiment of a method in accordance with claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, claimed subject matter is not limited in scope to this example. It will, of course, be understood that, although particular embodiments have just been described, claimed subject matter is not limited in scope to a particular embodiment or implementation.

In the preceding description, various aspects of claimed subject matter have been described. For purposes of explanation, systems and configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A method, comprising:
acquiring data from a computing system;
altering a facial model based, at least in part, on the acquired data; and
rendering a face in accordance with the facial model, wherein the rendered face includes a facial expression modulated to at least partially convey and/or represent the acquired data.

2. The method of claim 1, wherein the face represents a human face.

3. The method of claim 1, wherein the facial model includes a facial model matrix.

4. The method of claim 3, wherein the altering further comprises:
selecting a matrix based at least in part on the acquired data; and
altering the facial model matrix by using the selected matrix.

5. The method of claim 4, wherein altering the facial model comprises employing a linear transformation.

6. The method of claim 4, wherein the selected matrix is selected from a library of facial features, wherein at least a portion of the facial features are associated with a matrix.

7. The method of claim 1, wherein acquiring data comprises acquiring sensor data from one or more sensors.

8. The method of claim 7, wherein the sensor data represents at least one of: a computing system temperature, an activity level, a data transmission rate, a processor load and a computer age.

9. The method of claim 8, further comprising:
obtaining sensor data from one or more sensors communicatively coupled to one or more computing systems; and
rendering a plurality of faces including facial expressions on a display device based at least in part on the obtained sensor data.

10. The method of claim 9, wherein the plurality of computing systems comprises a server network.

11. A method, comprising:
rendering a face on a display device communicatively coupled to a computing system, wherein the rendered face includes a facial expression modulated in accordance with acquired data acquired from a sensor communicatively coupled to the computing system, and wherein the facial expression at least partially conveys and/or represents the acquired data.

12. The method of claim 11, wherein the rendered face represents a human face.

13. The method of claim 11, wherein the acquired data represents at least one of: a computing system temperature, an activity level, a data transmission rate, a processor load and a computer age.

14. The method of claim 13, further comprising:
obtaining sensor data from a plurality of sensors communicatively coupled to one or more of a plurality of computing systems; and
rendering a plurality of faces on a display device communicatively coupled to a computing system, each rendered face corresponding with at least one sensors.

15. The method of claim 14, wherein the plurality of computing systems comprises a server network.

16. An apparatus, comprising:
an input adapted to receive acquired data;
a facial feature library; and
a renderer adapted to associate the received data with one or more facial features of the facial feature library, and alter the facial model to form a rendered face, wherein the rendered face includes a facial expression modulated to at least partially convey and/or represent the acquired data.

17. The apparatus of claim 17, wherein the face represents a human face.

18. The apparatus of claim 17, wherein the one or more features of the facial feature library corresponds to a matrix.

19. The apparatus of claim 17, wherein the renderer is further adapted to:
alter the facial model matrix by using a corresponding facial feature matrix of the selected facial feature.

20. The apparatus of claim 19, wherein altering the facial model comprises employing a linear transformation.

21. The apparatus of claim 17, wherein the acquired data comprises sensor data.

22. The apparatus of claim 21, wherein the sensor data comprises at least one of: computing system temperature, activity level, data transmission rate, processor load and computer age.

23. The apparatus of claim 17, wherein the computing system comprises a server network.
